(19) United States
(12) Patent Application Publication
(10) Pub. No.: US 2026/0162848 A1
(43) Pub. Date: Jun. 11, 2026

(54) CONNECTING CABLE AND MEASURING DEVICE FORMED THEREWITH

(71) Applicant: Endress+Hauser Flowtec AG, Reinach (CH)

(72) Inventors: Guido Horoba, Gottenheim (DE); Andreas Strub, Weil am Rhein (DE)

(21) Appl. No.: 18/870,849

(22) PCT Filed: Jun. 1, 2023
(86) PCT No.: PCT/EP2023/064691

§ 371 Date: Dec. 2, 2024

(30) Foreign Application Priority Data
Jun. 2, 2022 (DE) 10 2022 114 039.3

(51) Int. Cl. H01B 7/40; H01B 1/02; H01B 7/29

(52) U.S. Cl. CPC H01B 7/40; H01B 1/02; H01B 7/292

(57) ABSTRACT

The connecting cable comprises at least two wires made of electrically conductive material and a multiplicity of connecting elements for the mechanical but electrically insulated connection of the wires and each made of a material having a dielectric strength of no less than 300 V/mm and a transformation temperature of over 400° C. The wires are spaced apart and electrically insulated from one another to form an electrical insulating resistance of no less than 1 MΩ. At least one segment of the wires may be bare. The connecting cable may be a component part of a measuring device and serve the purpose of electrically connecting an electrical component of the measuring device and an electronic measuring circuit of the measuring device to one another.

The invention relates to a connecting cable and a measuring device with such a connecting cable.

From US-A 2015/0211902, US-A 2016/0123783, US-A 2016/0138952, US-A 2016/0313162, US-A 2018/0364075, US-A 2019/0094054, US-A 2020/0251265, US-A 2021/0140804, or U.S. Pat. No. 4,876,898, measuring devices are known, each of which has at least one electrical, e.g., resistive, capacitive, electrodynamic, or piezoelectric, component, serving as a sensor element, e.g., a (sensor) coil, a (measuring) capacitor or a piezo element or a (platinum) measuring resistor, for converting at least one physical measurement variable into at least one electrical (measurement) signal with at least one signal parameter dependent upon the measurement variable, in particular an electrical (signal) voltage and/or an electrical (signal) current, and an electronic measuring circuit for processing the at least one electrical (measurement) signal. As, inter alia, disclosed in US-A 2015/0211902, US-A 2016/0138952, US-A 2016/0313162, US-A 2018/0364075, US-A 2020/0251265, US-A 2021/0140804, or U.S. Pat. No. 4,876,898, respectively, a 2- or multi-wire connecting cable with a first wire made of electrically conductive material and a second wire made of electrically conductive material, typically structurally identical to the first wire, serves to electrically connect the electrical component or sensor element to the measuring circuit, wherein the first and second wires of the connecting cable, consisting for example of a metal, are electrically connected to the electronic measuring circuit via a respective first (wire) end and to the sensor element via a respective second (wire) end. The component serving as the sensor element, the measuring circuit, as well as the connecting cable can also be arranged within a (protective) housing of the measuring system.

Each of the wires is, as, inter alia, also disclosed in US-A 2016/0313162, US-A 2020/0251265, or U.S. Pat. No. 4,876,898, typically also sheathed with a flexible (wire) insulation made of an electrically non-conductive or poorly conductive (insulating) material, in such a way that the first and second wires are spaced apart from each other and electrically insulated to form a, typically more than 1 MΩ (megaohm), electrical insulation resistance. Last but not least, when using such measuring devices in (high-temperature) applications in which the at least one component serving as a sensor element and the connecting cable connected to it are exposed to high operating temperatures of 350° C. (degrees Celsius) or more, typically a (high-)temperature-resistant, yet flexible, plastic, e.g., based upon polytetrafluoroethylene (PTFE) or a poly(organo)siloxane (silicone), and/or a (textile) fabric made from a (high-)temperature-resistant chemical fiber, e.g., a glass yarn, possibly also mixed with plastic and/or ceramic, serves as the insulating material.

Despite the use of such (high-)temperature-resistant (insulating) materials to form the (wire) insulation, temperature-related degeneration of the insulating material has occasionally been observed in measuring instruments of the type in question—for example, as a result of pyrolysis or oxidation. Although such changes to the insulating material do not necessarily have to lead to a reduction in the electrical breakdown strength of the (wire) insulation to a value below a (dielectric strength) value corresponding to a (minimum) breakdown voltage specified for the respective measuring device, typically between 200 V (volts) and 500 V, the functionality of the respective measuring system can nevertheless be significantly reduced; this is particularly the case because the aforementioned changes to the insulating material regularly also result in irreversible, but nevertheless undesirable, changes to its resistivity and/or its permittivity, and thus in corresponding changes to the line impedance of the respective connecting cable and the associated distortions of the respective (measurement) signal. In addition, condensation of gas escaping from the insulating material at high temperatures on the component serving as the sensor element could occasionally be observed, accompanied by the formation of electrically conductive films that occasionally lead to ground or short circuits.

Based upon the aforementioned prior art, it is an object of the invention to provide a connecting cable which has a permanently high stability both in terms of its mechanical and in terms of its electrical properties, even at high operating temperatures of over 350° C., over a long period of time or permanently.

To achieve the object, the invention consists of a connecting cable for, for example, high and/or low temperature resistant, electrical connection to an electrical (component) element, e.g., a coil, a capacitor, a piezo element, a (platinum) measuring resistor, or another sensor element, which, for example, is operated at least temporarily at a (nominal) maximum operating temperature of more than 350 C (degrees Celsius) and/or at least temporarily at a (nominal) minimum operating temperature of less than −40 C and/or serves as a sensor element, which, for example, 2-pole, connecting cable comprises:
a first wire made of electrically conductive material—for example, viz., made of a metal;
a second wire, for example structurally identical to the first wire, made of electrically conductive material—for example, viz., made of metal;
and a plurality of connecting elements, e.g., spherical or cylindrical and/or structurally identical, which serve for the mechanical and electrically insulated connection of the first and second wires, each connecting element made of a material having an electrical breakdown strength of not less than 300 V/mm (volts per millimeter) and a transformation temperature of more than 400° C. (degrees Celsius), e.g., not less than 500° C., e.g., a glass or a plastic, wherein each of the connecting elements is mechanically connected to both the first wire and the second wire in such a way that the first and second wires are spaced apart or electrically insulated from one another to form an electrical insulating resistance of no less than 1 MΩ (megaohm).

Furthermore, the invention also consists in using such a connecting cable at an (operating) temperature of more than 350° C. and/or in using such a connecting cable at an (operating) temperature of less than −40° C.

In addition, the invention also consists of a measuring device formed by means of such a connecting cable which further comprises an electrical component serving as a, for example, resistive, capacitive, electrodynamic, or piezoelectric sensor element, for converting at least one physical measurement variable into at least one electrical (measurement) signal, e.g., a voltage signal or a current signal, with at least one signal parameter dependent upon the measurement variable, e.g., an electrical (signal) voltage and/or an electrical (signal) current, as well as an electronic measuring circuit for processing the at least one electrical (measurement) signal, and/or in using such a measuring device for measuring at least one physical and/or chemical measurement variable of a fluid measurement substance, and/or a measurement substance which at least temporarily has a (measurement substance) temperature of more than 350° C. and/or at least temporarily has a (measurement substance) temperature of less than −40° C.

According to a first embodiment of the connecting cable of the invention, it is further provided that the first wire consist of a nickel-based alloy—for example, a nickel-iron alloy.

According to a second embodiment of the connecting cable of the invention, it is further provided that the first wire have a (wire) diameter which is not more than 1 mm (millimeter), e.g., not more than 0.5 mm, and/or not less than 0.05 mm—for example, not less than 0.1 mm.

According to a third embodiment of the connecting cable of the invention, it is further provided that the first wire have a (wire) length which is not more than 200 mm, e.g., not more than 150 mm, and/or not less than 50 mm—for example, not less than 70 mm.

According to a fourth embodiment of the connecting cable of the invention, it is further provided that the second wire consist of a nickel-based alloy—for example, a nickel-iron alloy.

According to a fifth embodiment of the connecting cable of the invention, it is further provided that the second wire have a (wire) diameter which is not more than 1 mm, e.g., not more than 0.5 mm, and/or not less than 0.05 mm—for example, not less than 0.1 mm.

According to a sixth embodiment of the connecting cable of the invention, it is further provided that the second wire have a (wire) length which is not more than 200 mm, e.g., not more than 150 mm, and/or not less than 50 mm—for example, not less than 70 mm.

According to a seventh embodiment of the connecting cable of the invention, it is further provided that one or more connecting elements each consist of a, for example, lead-free glass—for example, a sealing glass.

According to an eighth embodiment of the connecting cable of the invention, it is further provided that one or more connecting elements each consist of a ceramic—for example, Al₂O₃.

According to a ninth embodiment of the connecting cable of the invention, it is further provided that one or more connecting elements each consist of a, for example, semi-crystalline plastic—for example, a polyetheretherketone (PEEK), a polyethersulfone (PES), a polyetherimide (PEI), or a polyamideimide (PAI).

According to a tenth embodiment of the connecting cable of the invention, it is further provided that, within a connecting element, a respective minimum distance between the first and second wires be not less than 1 mm.

According to an eleventh embodiment of the connecting cable of the invention, it is further provided that, e.g., outside the connecting elements, a minimum distance between the first and second wires be more than 1 mm—for example, not less than 1.5 mm.

According to a twelfth embodiment of the connecting cable of the invention, it is further provided that a minimum distance between two adjacent connecting elements be not less than 1 mm and/or not more than 20 mm.

According to a thirteenth embodiment of the connecting cable of the invention, it is further provided that no more than 3 connecting elements be arranged per 1 cm (centimeter) of length (of the first and second wires).

According to a fourteenth embodiment of the connecting cable of the invention, it is further provided that a minimum distance between two adjacent connecting elements be not less than 2 times a (wire) diameter of the first and second wires and/or not more than 50 times a (wire) diameter of the first and second wires.

According to a fifteenth embodiment of the connecting cable of the invention, it is further provided that a maximum length of one or more connecting elements be not less than 1 mm and/or not more than 30 mm.

According to a sixteenth embodiment of the connecting cable of the invention, it is further provided that a largest diameter of one or more connecting elements be not less than 1 mm.

According to a seventeenth embodiment of the connecting cable of the invention, it is further provided that a total mass of all connecting elements (of the connecting cable) be less than 10 g (grams)—for example, not more than 5 g.

According to an eighteenth embodiment of the connecting cable of the invention, it is further provided that a mass of each of the connecting elements be always less than 2 g (grams)—for example, not more than 1 g; and/or

According to a nineteenth embodiment of the connecting cable of the invention, it is further provided that a (minimum) breakdown voltage between the first and second wires be not less than 200 V (volts)—for example, not less than 500 V.

According to a twentieth embodiment of the connecting cable of the invention, it is further provided that at least one (partial) segment extending between two adjacent connecting elements, e.g., several or all (partial) segments extending between adjacent connecting elements, of the first wire not be sheathed by insulation made of a solid insulating material or be designed as a (bare) overhead line.

According to a twenty-first embodiment of the connecting cable of the invention, it is further provided that at least one (partial) segment extending between two adjacent connecting elements, e.g., several or all (partial) segments extending between adjacent connecting elements, of the second wire not be sheathed by insulation made of a solid insulating material or be designed as a (bare) overhead line.

According to a twenty-third embodiment of the connecting cable of the invention, it is further provided that none of the (partial) segments of the first and second wires extending between two adjacent connecting elements be sheathed by a solid insulating material or have no wire insulation, and that said (partial) segments not be sheathed by a common (insulating material) sheath, and consequently the connecting cable (1000) have no solid insulating material in the region of said (partial) segments of the first and second wires (apart from the connecting elements).

According to a twenty-fourth embodiment of the connecting cable of the invention, it is further provided that the first and second wires each be embedded in the connecting elements—for example, viz., melted (to form a fused bond).

According to a twenty-fifth embodiment of the connecting cable of the invention, it is further provided that the first and second wires and the connecting elements each be connected to one another by means of a fused bond. Further developing this embodiment of the invention, it is further provided that the connecting elements consist of a (fused) glass, and that the first and second wires and the connecting elements each be connected to one another by means of a glass fused bond.

According to a twenty-sixth embodiment of the connecting cable of the invention, it is further provided that a first (minimum) distance between a first pair of adjacent connecting elements deviate from a second (minimum) distance between a second pair of adjacent connecting elements, e.g., in such a way that the first (minimum) distance be more than 5 mm, in particular not less than 10 mm, smaller than the second (minimum) distance.

According to a further development of the connecting cable of the invention, it further comprises: a feedthrough element, e.g., designed as a component of a (multi-pin) plug connection system having more than two contact elements, wherein the feedthrough element has a base body made of a material having an electrical breakdown strength of not less than 300 V/mm and a transformation temperature of more than 400° C., e.g., not less than 500° C., e.g., a glass or a plastic, as well as first and second contact elements embedded in the base body, e.g., each formed by means of a plug contact or a plug sleeve, and wherein the first wire is electrically connected by a first (wire) end to the first contact element, and the second wire is electrically connected by a first (wire) end to the second contact element—for example, by means of a material bond. According to a further embodiment of the invention, it is further provided that one or more connecting elements consist of the same material as the base body.

According to an embodiment of the measuring device of the invention, it is further provided that the first and second wires of the connecting cable be electrically connected to the electronic measuring circuit by means of a respective first (wire) end, and to the electrical (component) element by means of a respective second (wire) end, e.g., in such a way that a second (wire) end of the first wire is electrically connected to a first (connection) electrode of the electrical component, and a second (wire) end of the second wire is electrically connected to a second (connection) electrode of the electrical (component) element.

According to a further development of the measuring device of the invention, it further comprises: a, for example, modular and/or chambered (protective) housing, within which the electrical (component) element, the measuring circuit, and the connecting cable of the (protective) housing are arranged, and it is further provided that the first and second wires of the connecting cable be electrically connected to the electronic measuring circuit by means of a respective first (wire) end, and to the electrical (component) element by means of a respective second (wire) end, e.g., in such a way that a second (wire) end of the first wire is electrically connected to a first (connection) electrode of the electrical component, and a second (wire) end of the second wire is electrically connected to a second (connection) electrode of the electrical (component) element.

According to a first embodiment of this further development of the measuring device, it is further provided that the connecting cable run at least partially within a chamber of the (protective) housing filled with noble gas—for example, argon and/or krypton.

According to a second embodiment of this further development of the measuring device, it is further provided that a (partial) segment of the first wire located between the electrical (component) element and the measuring circuit, e.g., run in a freely swinging manner, as well as a (partial) segment of the second wire located between the electrical (component) element and the measuring circuit, e.g., run in a freely swinging manner, be spaced from a wall of the (protective) housing, e.g., in such a way that a respective minimum distance between the wall of the (protective) housing and the first or second wire is not less than 1 mm—for example, more than 2 mm.

The invention as well as advantageous embodiments thereof are explained in more detail below based upon exemplary embodiments shown in the figures of the drawing. Identical or identically acting or identically functioning parts are provided with the same reference signs in all figures; for reasons of clarity or if it appears sensible for other reasons, reference signs mentioned before are dispensed with in subsequent figures. Further advantageous embodiments or developments, especially, combinations of partial aspects of the invention that were initially explained only separately, furthermore emerge from the figures of the drawing and/or from the claims themselves.

In the figures, in detail:

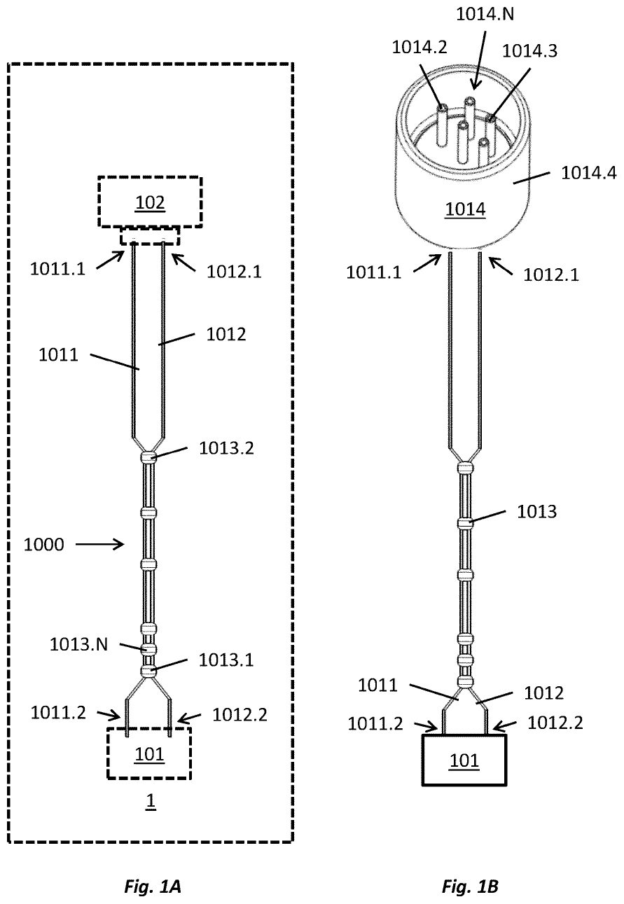

FIG. 1A, B shows exemplary embodiments of a connecting cable according to the invention;

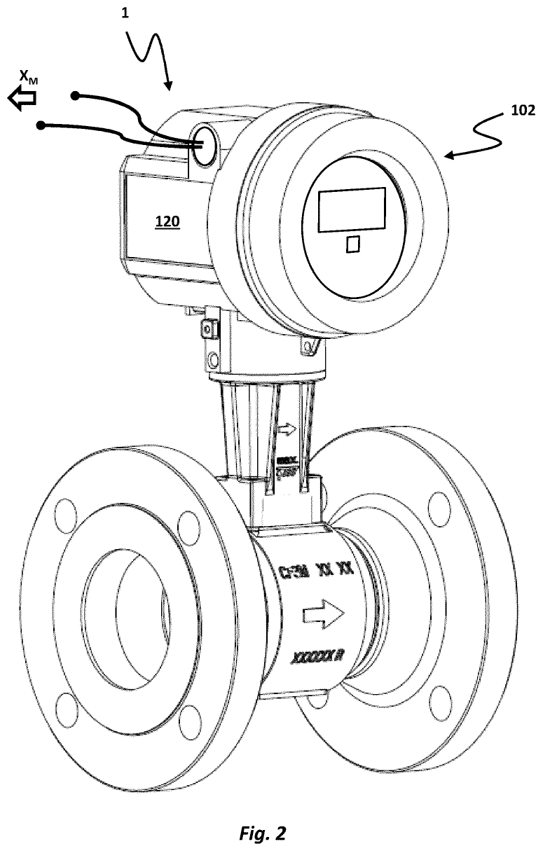

FIG. 2 shows a perspectival side view of an exemplary embodiment of a measuring device;

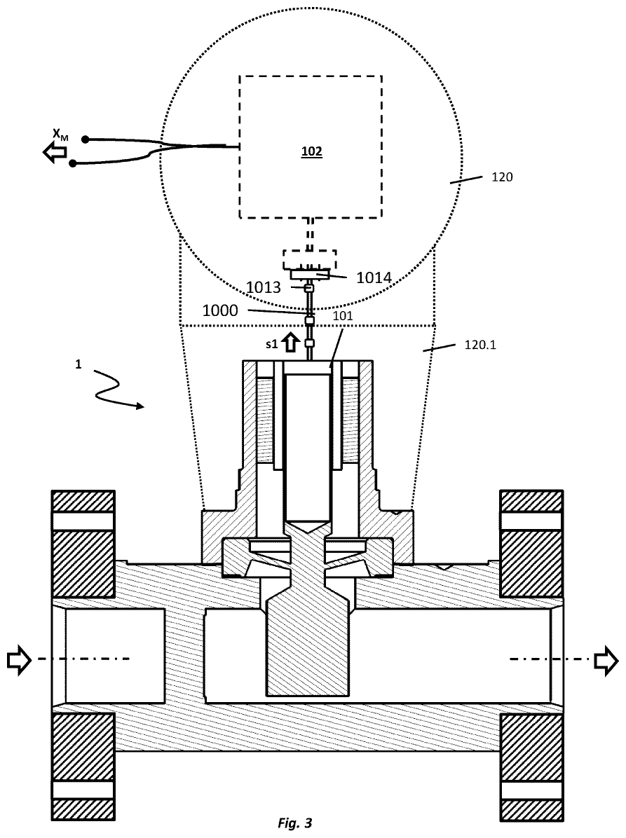

FIG. 3 shows a first sectional side view of the measuring device according to FIG. 2; and

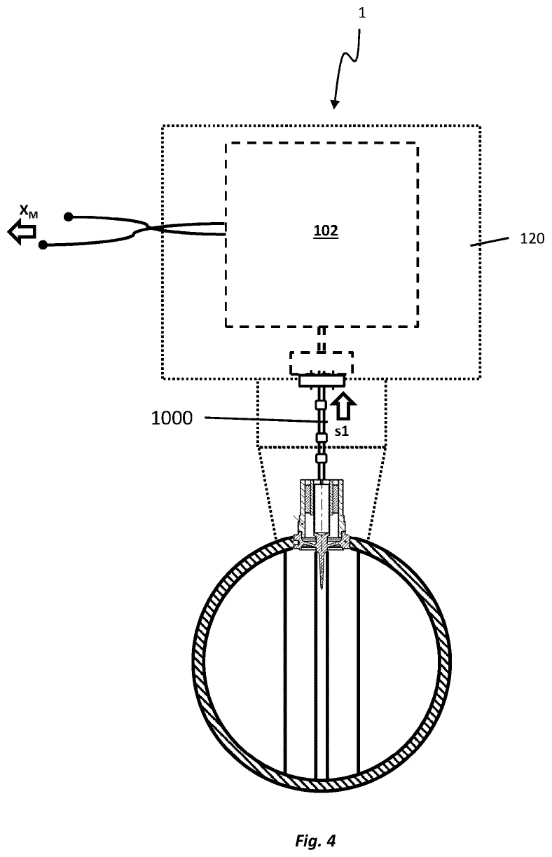

FIG. 4 shows a second sectional side view of the measuring device according to FIG. 2.

FIGS. 1A and 1B each schematically show an exemplary embodiment of a connecting cable 1000 according to the invention-for example, viz., a 2-pole or 2-wire connecting cable which is provided or suitable for being connected to an electrical (component) element 101. The (component) element 101 can, for example, also be designed as a sensor element or serve as a sensor element of an (industrial) measuring device 1. An exemplary embodiment of such a measuring device is shown schematically in FIGS. 2, 3, and 4. The electrical (component) element 101 can accordingly also, for example, be an electrical (component) element electrically connected via a connecting cable 1000 to an electronic measuring circuit 102 of the measuring device 1 and/or a (sensor) coil, a (measuring) capacitor, a piezo element, or a (platinum) measuring resistor. Such a measuring device can, for example, be a pressure measuring device, a temperature measuring device, a fill-level measuring device or, as shown schematically in FIGS. 2, 3, and 4, a flow measuring device, in particular, viz., also a vortex flow measuring device (determining a volume or mass flow based upon a Kármán's vortex street).

According to one embodiment of the invention, the connecting cable (or the measuring system formed therewith) is also designed to be high temperature resistant, in particular designed for an operating temperature of more than 350° C. (degrees Celsius), or the connecting cable is designed to be connected to the electrical (component) element 102, which can also be operated at, for example, a (nominal) maximum (operating) temperature of more than 350° C. Alternatively or in addition, the connecting cable 1000 can also be provided to be operated at a (nominal) minimum (operating) temperature of less than 350° C.—for example, even at a very low (operating) temperature of, viz., less than —40° C.

The connecting cable 1000 comprises a first wire 1011 made of electrically conductive material, (at least) one second wire 1012, made of electrically conductive material—for example, structurally identical to wire 1011. In addition, the connecting cable 1000 according to the invention comprises a plurality (more than two) (N>2) of, for example, spherical or cylindrical, and/or structurally identical connecting elements 1013 (1013.1, 1013.2, . . . 1013.N) which serve for the mechanical and electrically insulated connection of the first and second wires, and each of which, as also schematically shown in FIG. 1A or 1B, is mechanically connected to both the wire 1011 and the wire 1012, in such a way that the first and second wires are spaced apart or electrically insulated from one another to form an electrical insulating resistance of no less than 1 MΩ (megaohm); this according to a further embodiment of the invention in particular in such a way that a (nominal) operating voltage of the connecting cable 1000 or a (minimum) breakdown voltage between the first and second wires is not less than 200 V (volts), in particular not less than 500 V.

The material of the first and/or second wires of the connecting cable 1000 can in particular be a metal, for example, viz., (fine) silver or a nickel-based alloy, such as a nickel-iron alloy. According to a further embodiment of the invention, a maximum length or a maximum diameter of one or more of the connecting elements 1013 is not less than 1 mm and/or not more than 30 mm, and/or the first and/or second wires each have a (wire) length that is not more than 200 mm, in particular not more than 150 mm, and/or not less than 50 mm, in particular not less than 70 mm. According to a further embodiment of the invention, the connecting elements are further connected to the first and second wires in such a way that, within each connecting element 1013 (1013.1, 1013.2, 13.N), a respective minimum distance between the first and second wires is not less than 1 mm (millimeter), and/or the first and second wires are arranged in such a way that, in particular also outside the connecting elements 1013, a minimum distance between the first and second wires is (permanently) more than 1 mm—for example, also not less than 1.5 mm.

Not least in the case described above that the minimum distance between the first and second wires outside the connecting elements is more than 1 mm, or it is ensured that, viz., the same minimum distance is permanently maintained, it is further also possible to form the first and second wires at least partially as a (bare) overhead line. Hence, according to a further embodiment of the invention, at least one (partial) segment of the wire 1011 extending between two adjacent connecting elements is not sheathed by insulation made of a solid insulating material, and/or a (partial) segment of the wire 1012 extending between two adjacent connecting elements is not sheathed by insulation made of a solid insulating material. For example, several or all (partial) segments of the first and/or second wires extending between adjacent connecting elements 1013 (1013.1, 1013.2, 1013.N) may not be sheathed by insulation made of a solid insulating material, in particular, viz., in such a way that none of the aforementioned (partial) segments of the first and second wires is sheathed per se by a solid insulating material, and consequently has no wire insulation, and said (partial) segments are also not sheathed by a common (insulating material) sheath such as a cable sheath so that the connecting cable 1000 does not have any solid insulating material in the region of said (partial) segments of the first and second wires (apart from the connecting elements). Due to such a reduction in the (solid) insulating material used for the wire 1012 or the wire 1013 (on the connecting elements), a connecting cable 1000 with a line impedance remaining stable even at very high and/or very low operating temperatures can be provided in a very simple manner.

In order to enable the aforementioned high operating temperatures as well as the aforementioned high operating voltages (if necessary, also with the first and second wires designed as overhead lines), the connecting elements 1013 in the connecting cable 1000 according to the invention also consist of a material which on the one hand has an electrical breakdown strength of not less than 300 V/mm (volts per millimeter) and on the other has a transformation temperature (glass transition temperature) of more than 400° C., e.g., not less than 500° C., or the connecting elements 1013 are each made of such a material. According to a further embodiment, one or more, e.g., all, connecting elements 1013 each accordingly consist of a glass, e.g., a lead-free glass and/or a sealing glass, and/or each consist of a ceramic, e.g., an aluminum oxide ceramic (Al₂O₃) or a glass ceramic, and/or each consists of a (semi-crystalline) plastic—for example, a polyetheretherketone (PEEK), a polyethersulfone (PES), a polyetherimide (PEI), or a polyamideimide (PAI). According to a further embodiment of the invention, the first and second wires are each embedded in the connecting elements 1013, e.g., viz., melted (to form a fused bond), and/or the first and second wires and the connecting elements 1013 are each connected to one another by means of a fused bond—for example, viz., in the above-mentioned case that the connecting elements 1013 consist of a (fused) glass, by means of a glass fused bond.

Last but not least, in the case already mentioned that the connecting cable 1000 serves or is provided to be electrically connected to a measuring circuit (102) of a measuring device (1), the connecting cable 1000 comprises, according to a further embodiment, a feedthrough element 1014 having a base body 1014.1 and first and second contact elements 1014.2, 1014.3 each embedded in the base body. The base body 1014.1 can also be arranged, for example, in a sleeve 1014.4 of the feedthrough element 1014 and/or formed in-situ within the sleeve 1014.4 by first allowing liquid material to harden or solidify within the sleeve 1014.4.

In this embodiment, the wire 1011 is also electrically connected by a first (wire) end 1011.1 to the first contact element 1014.2 (of the feedthrough element), and the wire 1012 is electrically connected by a first (wire) end 1012.1 to the second contact element (of the feedthrough element)—for example, also by means of a material bond. The feedthrough element 1014 can be designed, for example, as a component of a (multi-pin) plug connection system having more than two contact elements (1014.2, 1014.2, . . . 1014.N) so that the contact elements can each be formed, for example, by means of a plug contact or a plug sleeve. Alternatively or in addition, the base body can advantageously consist of a material, e.g., a glass or a plastic, which has an electrical breakdown strength of not less than 300 V/mm and a transformation temperature of more than 400° C., in particular not less than 500° C., or the base body 1014.1 can be made of such a material. According to a further embodiment of the invention, one or more, e.g., all, connecting elements of the connecting cable are also made of the same material as the base body 1014.1 (of the feedthrough element), and/or the mass of each of the connecting elements is less than 2 g (grams), in particular not more than 1 g.

In order to achieve the lowest possible overall installation mass of the connecting cable 1014 or the highest possible vibration resistance of the connecting cable, not least in the event of excitation of one or more of its mechanical resonance frequencies, according to a further embodiment of the invention, a total mass of all connecting elements (of the connecting cable) is less than 10 g (grams), e.g., viz., not more than 5 g, and/or the first and/or second wires each have a (wire) diameter of not less than 0.05 mm, in particular not less than 0.1 mm, not least also to achieve a sufficiently high tear resistance. Alternatively or in addition, the (wire) diameter of the first and/or second wires can also be selected so that it does not exceed 1 mm—for example, also not more than 0.5 mm. In order to achieve the lowest possible installation mass on the one hand and the highest possible stability of the aforementioned minimum distance between the first and second wires on the other, according to a further embodiment of the invention, a minimum distance between two adjacent connecting elements is not less than 1 mm and/or not less than twice a (wire) diameter of the first and second wires. Alternatively or in addition, the aforementioned minimum distance between two adjacent connecting elements can also be selected in such a way that it is not more than 20 mm and/or not more than 50 times the (wire) diameter of the first and second wires, and/or the connecting elements can also be arranged in such a way that not more than 3 connecting elements are arranged per 1 cm length (of the first and second wires). According to a further embodiment of the invention, it is further provided that—for example, in order to provide a grip zone (1013.1+1013.N) simplifying handling of the connecting cable 1014 during its (final) assembly—a first (minimum) distance between a first pair of adjacent connecting elements (1013.1, 1013.N) deviate from a second (minimum) distance between a second pair of adjacent connecting elements; this in particular in such a way that the aforementioned first (minimum) distance is more than 5 mm, in particular not less than 10 mm, smaller than the aforementioned second (minimum) distance.

As already indicated several times, the connecting cable 1000 together with the aforementioned electrical component 101 connected thereto can also be components or parts of an (industrial) measuring device (1), e.g., viz., a measuring device for measuring at least one physical or chemical measured variable of a fluid measuring substance, and/or a measuring substance which at least temporarily has a (measuring substance) temperature of more than 350° C. and/or at least temporarily a (measuring substance) temperature of less than −40° C. The component 101 can accordingly, as already indicated, be designed for example as a resistive, capacitive, electrodynamic, or piezoelectric sensor element for converting at least one physical measurement variable, e.g., a pressure, a temperature, or a volume or mass flow of a fluid, into at least one electrical (measurement) signal s1, e.g., viz., a voltage signal or a current signal, with at least one signal parameter dependent upon the measurement variable, in particular an electrical (signal) voltage and/or an electrical (signal) current.

According to a further embodiment of the invention, it is also provided that the aforementioned measuring device, as also shown schematically in FIGS. 3 and 4, have an electronic measuring circuit 102 for processing the at least one electrical (measurement) signal s1, e.g., viz., for determining measured values X_{M} representing at least one measured variable of a fluid measuring substance guided within the measuring device based upon the (measurement) signal s1, and that the first and second wires of the connecting cable 1000 be electrically connected to the aforementioned electronic measuring circuit 102 (of the measuring device) by means of the respective first (wire) end 1011.1, 1012.1, e.g., also received by the aforementioned feedthrough element 1014, and to the aforementioned electrical (component) element 101 by means of a respective second (wire) end 1011.2, 1012.2, e.g., also in such a way that a second (wire) end of the first wire is electrically connected to a first (connection) electrode of the electrical component 101, and a second (wire) end of the second wire is electrically connected to a second (connection) electrode of the electrical component 101. As also schematically shown in FIGS. 2, 3, and 4 or as readily apparent from their combination, the aforementioned measuring device 1 can further comprise a, for example, modular and/or (multiple) chambered (protective) housing 120, and the electrical (component) element 101, the measuring circuit 102, and the connecting cable 1000 can be arranged within said (protective) housing 120. According to a further embodiment of the invention, the (protective) housing 102 (of the measuring device) further comprises at least one chamber 120.1 filled with noble gas, e.g., viz., argon (Ar) and/or krypton (Kr), and the connecting cable is run at least partially within the same chamber.

According to another embodiment of the invention, it is further provided that a (partial) segment of the wire 1011 located between the electrical (component) element 101 and the measuring circuit 102 as well a (partial) segment of the wire 1012 located between the electrical (component) element 101 and the measuring circuit 102 be spaced apart from a wall of the (protective) housing 120, in particular in such a way that a respective minimum distance between the wall of the (protective) housing 120 and the first or second wire is not less than 1 mm, in particular more than 2 mm. Alternatively or in addition, the aforementioned (partial) segment of the first and/or second wire can, as also schematically shown in FIG. 3 or 4, be run in a freely swinging manner, for example, at least within the aforementioned chamber.

1-14. (canceled)

15. A connecting cable for electrical connection to an electrical component that is operated at least temporarily at a maximum operating temperature of more than 350° C. and/or at least temporarily at a minimum operating temperature of less than −40° C., the connecting cable comprising:
a first wire made of an electrically conductive material;
a second wire made of the electrically conductive material; and
a plurality of connecting elements that serve for the mechanical and electrically insulated connection of the first and second wires, each connecting element made of a material having an electrical breakdown strength of not less than 300 V/mm and a transformation temperature of more than 400° C., wherein each of the connecting elements is mechanically connected to both the first wire and the second wire such that the first and second wires are spaced apart or electrically insulated from one another to form an electrical insulating resistance of no less than 1 MΩ.

16. The connecting cable according to claim 15,
wherein the first wire is embodied of a nickel-based alloy; and/or
wherein the first wire has a diameter of not more than 1 mm; and/or
wherein the first wire has a length of not more than 200 mm.

17. The connecting cable according to claim 15,
wherein the second wire is embodied of a nickel-based alloy; and/or
wherein the second wire has a diameter of not more than 1 mm; and/or
wherein the second wire has a length of not more than 200 mm.

18. The connecting cable according to claim 16,
wherein one or more connecting elements is each embodied of a lead-free glass; and/or
wherein one or more connecting elements is each embodied of a ceramic; and/or
wherein one or more connecting elements is each embodied of a semi-crystalline plastic; and/or
wherein, within a connecting element, a minimum distance between the first and second wires is not less than 1 mm; and/or
wherein a minimum distance between the first and second wires is more than 1 mm; and/or
wherein no more than 3 connecting elements per 1 cm length of the first and second wires are arranged; and/or
wherein not less than 2 connecting elements per 50 mm length of the first and second wires are arranged; and/or
wherein a minimum distance between two adjacent connecting elements is not less than mm and/or not more than 20 mm; and/or
wherein a minimum distance between two adjacent connecting elements is not less than times the wire diameter of the first and second wires and/or not more than 50 times the wire diameter of the first and second wires; and/or
wherein a maximum distance between two adjacent connecting elements is not less than mm and/or not more than 20 mm; and/or
wherein a maximum distance between two adjacent connecting elements is not less than times the wire diameter of the first and second wires and/or not more than 50 times the wire diameter of the first and second wires; and/or
wherein a first minimum distance between a first pair of adjacent connecting elements differs from a second minimum distance between a second pair of adjacent connecting elements; and/or
wherein a maximum length of one or more connecting elements is not less than 1 mm and/or not more than 30 mm; and/or
wherein a maximum diameter of one or more connecting elements is not less than 1 mm; and/or
wherein the mass of each of the connecting elements is less than 2 grams; and/or
wherein the total mass of all connecting elements of the connecting cable is less than 10 grams; and/or
wherein the first and second wires are each embedded in the connecting elements to form a fused bond; and/or
wherein the first and second wires and the connecting elements are each connected to one another by means of a fused bond.

19. The connecting cable according to claim 15, wherein a minimum breakdown voltage between the first and second wires is not less than 200 V.

20. The connecting cable according to claim 15,
wherein at least one partial segment extending between two adjacent connecting elements of the first wire is not sheathed by insulation made of a solid insulating material or is designed as a bare overhead line; and/or
wherein at least one partial segment extending between two adjacent connecting elements of the second wire is not sheathed by insulation made of a solid insulating material or is designed as a bare overhead line.

21. The connecting cable according to claim 15, further comprising:
a base body made of a material having an electrical breakdown strength of not less than 300 V/mm and a transformation temperature of more than 400° C.; and
feedthrough elements embedded in the base body and having first and second contact elements,
wherein the first wire is electrically connected by a first wire end to the first contact element, and the second wire is electrically connected by a first wire end to the second contact element.

22. The connecting cable according to claim 21, wherein one or more connecting elements are embodied of the same material as the base body.

23. A measuring device, comprising:
a resistive, capacitive, electrodynamic, or piezoelectric electrical component serving as a sensor element for converting at least one physical measurement variable into at least one electrical measurement signal with at least one signal parameter dependent upon the measurement variable;
an electronic measuring circuit for processing the at least one electrical measurement signal; and
a connecting cable for electrical connection to the electrical component that is operated at least temporarily at a maximum operating temperature of more than 350° C. and/or at least temporarily at a minimum operating temperature of less than −40° C., the connecting cable including:
a first wire made of an electrically conductive material;
a second wire made of the electrically conductive material; and
a plurality of connecting elements that serve for the mechanical and electrically insulated connection of the first and second wires, each connecting element made of a material having an electrical breakdown strength of not less than 300 V/mm and a transformation temperature of more than 400° C., wherein each of the connecting elements is mechanically connected to both the first wire and the second wire such that the first and second wires are spaced apart or electrically insulated from one another to form an electrical insulating resistance of no less than 1 MΩ.

24. The measuring device according to claim 23, wherein the first and second wires of the connecting cable are electrically connected to the electronic measuring circuit by a respective first wire end, and to the electrical component element by means of a respective second wire end.

25. The measuring device according to claim 24, further comprising:
a protective housing, wherein the electrical component, the measuring circuit, and the connecting cable are arranged within the protective housing.

26. The measuring device according to claim 25,
wherein the connecting cable is at least partially run within a chamber of the protective housing filled with noble gas; and/or
wherein a partial segment of the first wire located between the electrical component and the measuring circuit as well as a partial segment of the second wire located between the electrical component and the measuring circuit are spaced from a wall of the protective housing.
